(19) United States
(12) Patent Application Publication
(10) Pub. No.: US 2024/0363042 A1
(43) Pub. Date: Oct. 31, 2024

(54) HEAD-UP DISPLAY WITH REDUCED OBSTRUCTION

(71) Applicant: Continental Automotive Technologies GmbH, Hannover (DE)

(72) Inventor: Nils Palm, Babenhausen (DE)

(73) Assignee: Continental Automotive Technologies GmbH, Hannover (DE)

(21) Appl. No.: 18/688,497

(22) PCT Filed: Aug. 18, 2022
(86) PCT No.: PCT/DE2022/200190

§ 371 Date: Mar. 1, 2024

(30) Foreign Application Priority Data
Sep. 1, 2021 (DE) 10 2021 209 616.6

(51) Int. Cl. G09G 3/00; B60K 35/233

(52) U.S. Cl. CPC G09G 3/001; B60K 35/233; G09G 2320/02; G09G 2340/00; G09G 2380/10

(57) ABSTRACT

The present disclosure relates to a method, a computer program comprising instructions and a device for reducing masking by a virtual image of a head-up display of a transport. The disclosure additionally relates to a head-up display for a transport in which such a method or such a device is used. In a first step, a horizon and/or a vanishing point is determined. Afterward, an image to be displayed is subdivided into a plurality of partial areas. In this case, the partial areas are trapezoidal and their size varies over the area of the image to be displayed. For the individual partial areas, masking areas are determined and checking is carried out to ascertain whether the determined masking area exceeds a permissible size for at least one of the partial areas. If this is the case, a warning signal is output. Finally, at least one measure for reducing the masking is implemented in response to the warning signal.

### CROSS REFERENCE TO RELATED APPLICATIONS

This US patent application claims the benefit of PCT patent application No. PCT/DE2022/200190, filed Aug. 18, 2022, which claims the benefit of German patent application No. 10 2021 209 616.6, filed Sep. 1, 2021, both of which are hereby incorporated by reference.

### TECHNICAL FIELD

The present disclosure relates to a method, a computer program comprising instructions and a device for reducing masking by a virtual image of a head-up display of a transport. The disclosure additionally relates to a head-up display for a transport in which such a method or such a device is used.

### BACKGROUND

A head-up display, also referred to as HUD, is understood to mean a display system in which the observer may maintain their viewing direction since the contents to be represented are inserted into their field of view. While such systems were originally used primarily in the aviation sector due to their complexity and costs, they are now also being used in large-scale production in the automotive sector.

Head-up displays generally consist of an image generator, an optics unit, and a mirror unit. The image generator generates the image. The optics unit directs the image onto the mirror unit. The image generator is often also referred to as an imaging unit or PGU (picture generating unit). The mirror unit is a partially reflecting, light-transmissive pane. The observer thus sees the contents represented by the image generator as a virtual image and at the same time the real world behind the pane. In the automotive sector, the windshield is often used as mirror unit, and its curved shape must be taken into account in the representation. Due to the interaction between the optics unit and the mirror unit, the virtual image is an enlarged representation of the image generated by the image generator.

For head-up displays, at the present time use is usually made of a liquid crystal display (LCD) with backlighting for the imaging unit. Displays based on OLED technology (OLED: Organic Light Emitting Diode) and DMD technology (Digital Micromirror Device) are used as well.

Against this background, DE 10 2015 215 180 A1 describes a head-up display for a vehicle. The head-up display comprises a display device for emitting light with an image generating unit, and an image control unit for controlling the image generating unit. In this case, a reduced brightness is set in regions of the display device in dependence on the viewing direction of a user. This makes it possible to reduce the energy expenditure during image generation. However, it does not prevent the user from being dazzled if the ambient brightness is low and the regions of the display device that are not reduced in terms of their brightness are set to be too bright.

In the case of large and bright head-up displays that cover a large region of the driver's field of view, the problem of masking arises in addition to the problem of dazzling. It is necessary to avoid a situation in which relevant objects such as e.g. cyclists, pedestrians, animals or a soccer ball rolling onto the road may be masked by a bright region in the virtual image of the head-up display and may therefore not be perceived by the driver.

A general approach for solving this problem area consists in avoiding relatively large regions on the LCD display that are bright over the whole area, and giving preference to the virtual image being constructed from thin lines, instead of using filled areas.

In order to monitor whether bright regions may result in masking, the virtual image may be decomposed into small rectangles, so-called tiles, which are each checked for their transparency. In this case, the transparency serves as a measure of the masking area of the tile. The checking should take into consideration the fact that the transparency is permitted to have a magnitude only one quarter that of the maximum permissible masking area. This takes account of the fact that the areally bright region could be divided among four tiles in the worst case.

### SUMMARY

It is an object of the disclosure to provide improved solutions for reducing masking by a virtual image of a head-up display.

This object is achieved by a method having the features of claim 1, by a computer program comprising instructions having the features of claim 8 and by a device having the features of claim 9. The dependent claims relate to configurations of the disclosure.

According to a first aspect of the disclosure, a method for reducing masking by a virtual image of a head-up display of a transport comprises the steps of subdividing an image to be displayed into a plurality of partial areas, wherein the partial areas are trapezoidal and their size varies over the area of the image to be displayed; determining masking areas for the individual partial areas; and outputting a warning signal if the determined masking area exceeds a permissible size for at least one of the partial areas.

According to a further aspect of the disclosure, a computer program comprises instructions which, when executed by a computer, cause the computer to carry out the following steps for reducing masking by a virtual image of a head-up display of a transport by subdividing an image to be displayed into a plurality of partial areas, wherein the partial areas are trapezoidal and their size varies over the area of the image to be displayed; determining masking areas for the individual partial areas; and outputting a warning signal if the determined masking area exceeds a permissible size for at least one of the partial areas.

The term computer should be understood in the broad sense in this case. In particular, it also includes control units, controllers, embedded systems and other processor-based data processing devices.

The computer program may be provided for electronic retrieval or may be stored on a computer-readable storage medium, for example.

According to a further aspect of the disclosure, a device for reducing masking by a virtual image of a head-up display of a transport comprises a subdividing module for subdividing an image to be displayed into a plurality of partial areas, wherein the partial areas are trapezoidal and their size varies over the area of the image to be displayed; a processing module for determining masking areas for the individual partial areas; and a warning module for outputting a warning signal if the determined masking area exceeds a permissible size for at least one of the partial areas.

In the case of the solution according to the disclosure, the image to be displayed is decomposed into trapezoidal tiles whose size varies within the image. The smaller an object overlaid by the image to be displayed is perceived by the observer, the smaller, too, the tiles in the respective region. Since the perceived size of an object varies with the distance of the object, the tiles are small in those regions of the image which overlay objects far away. At the sides of the image, the perceived objects are closer; therefore, the tiles may also be larger. In contrast to the subdivision of the image to be displayed into rectangles, the maximum size of the bright area that is still tolerable varies in magnitude in the different image regions. In addition, the subdividing axes do not run horizontally and vertically through the field of view. Instead, the subdivision corresponds to the viewing axes and thus the size relationships of the perceived image.

According to one aspect of the disclosure, when determining the masking areas, a transparency of the partial areas is considered as a measure of the masking area. The transparency is an easily determinable measure of the magnitude of the percentage proportion of the masked area within the respective partial area.

According to one aspect of the disclosure, before outputting a warning signal, checking is carried out to ascertain whether the determined masking area exceeds a permissible size for two or more adjacent partial areas. In the worst case, the areally bright region that results in masking is shared among four partial areas. The permissible size of the masking area within a partial area is chosen to take account of this situation. However, if checking of an adjacent partial area reveals that there the permissible size of the masking area is not exceeded and a tolerable masking is present overall, the outputting of a warning signal may be dispensed with.

According to one aspect of the disclosure, the partial areas have a decreasing size from an edge region of the image to be displayed to the horizon and/or to a vanishing point. The sizes of the image perceived by the observer follow the vanishing point, i.e. objects are perceived all the smaller the nearer to the vanishing point or horizon they are situated. Accordingly, the size of the trapezoidal partial areas is also all the smaller the nearer to the vanishing point or horizon they are situated.

According to one aspect of the disclosure, determining the horizon is carried out by determining an inclination of the means of transport. Alternatively or additionally, determining the vanishing point is carried out by determining a viewing direction of an observer. The location of the horizon may easily be determined from the inclination of the means of transport, which may be detected e.g. by gyroscope sensors. The vanishing point may in turn easily be determined from the viewing direction of the observer, in particular the vertical viewing direction. The viewing direction of the observer may be detected e.g. by an interior camera.

According to one aspect of the disclosure, at least one measure for reducing the masking is implemented in response to the warning signal. By way of example, at least one image element that causes the masking can be displaced. What may be achieved by displacing the image element into a partial area situated somewhat further in the direction of the image edge is that the resulting masking area no longer exceeds the permissible size. Alternatively or additionally, the area masked by the image element may be reduced. For this purpose, e.g. the image element may be constructed from thin lines or merely be represented as a contour.

According to one aspect of the disclosure, a display of image elements in the region of the horizon or in the region of the vanishing point is prevented. In order to further increase safety, it is advantageous if the horizon per se or the vanishing point is totally omitted from the display of image elements. Particularly at high speed, for example an end of a backup may appear very small and easily be masked.

A method according to the disclosure or a device according to the disclosure is used in a head-up display for a transport, e.g. in a head-up display for a motor vehicle. Such a head-up display is distinguished by increased safety for the driver since masking of relevant objects in the driver's field of view is reduced or completely avoided.

### BRIEF DESCRIPTION OF THE FIGURES

Further features of the present disclosure will become apparent from the following description and the appended claims in conjunction with the figures.

FIG. 1 schematically shows a head-up display according to the prior art for a motor vehicle;

FIG. 2 shows a subdivision of an image to be displayed into rectangular partial areas;

FIG. 3 shows a subdivision of an image to be displayed into trapezoidal partial areas with a varying size;

FIG. 4 schematically shows a method for reducing masking by a virtual image of a head-up display of a transport;

FIG. 5 schematically shows a first embodiment of a device for reducing masking by a virtual image of a head-up display of a transport; and

FIG. 6 schematically shows a second embodiment of a device for reducing masking by a virtual image of a head-up display of a transport.

### DETAILED DESCRIPTION

For a better understanding of the principles of the present disclosure, embodiments of the disclosure are explained below in greater detail with reference to the figures. The same reference signs are used for identical or functionally identical elements in the figures and are not necessarily described again for each figure. It goes without saying that the invention is not restricted to the embodiments illustrated and that the features described can also be combined or modified without departing from the scope of protection of the disclosure as defined in the appended claims.

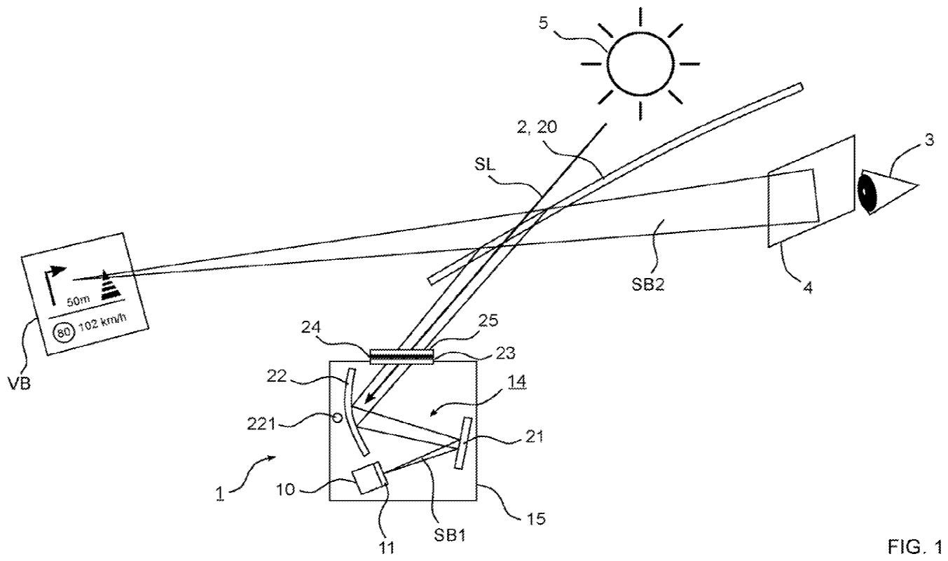

FIG. 1 shows a schematic diagram of a head-up display for a motor vehicle. The head-up display has a display device 1 with an imaging unit 10 and an optics unit 14. A beam SB1 emanates from a display element 11 and is reflected by a folding mirror 21 onto a curved mirror 22 that reflects said beam in the direction of a mirror unit 2. The mirror unit 2 is illustrated here as a windshield 20 of the motor vehicle. From there, the beam SB2 travels in the direction of an eye of an observer 3.

The observer 3 sees a virtual image VB that is located outside the motor vehicle above the engine hood or even in front of the motor vehicle. Due to the interaction between the optics unit 14 and the mirror unit 2, the virtual image VB is an enlarged representation of the image displayed by the display element 11. A speed limit, the current vehicle speed and navigation instructions are symbolically represented here. As long as the eye of the observer 3 is located within an eyebox 4, indicated by a rectangle, all elements of the virtual image VB are visible to the observer 3. If the eye of the observer 3 is located outside of the eyebox 4, the virtual image VB is only partially visible to the observer 3 or not at all. The larger the eyebox 4, the less restricted the observer is when choosing their seating position.

The curvature of the curved mirror 22 is adapted to the curvature of the windshield 20 and ensures that the image distortion is stable over the entire eyebox 4. The curved mirror 22 is rotatably mounted by a mounting 221. The rotation of the curved mirror 22 that this allows makes it possible to displace the eyebox 4 and thus to adapt the position of the eyebox 4 to the position of the observer 3. The folding mirror 21 serves to ensure that the path traveled by the beam SB1 between the display element 11 and the curved mirror 22 is long and at the same time the optics unit 14 is nevertheless compact. The imaging unit 10 and the optics unit 14 are separated from the environment by a housing 15 having a transparent cover plate 23. The optical elements of the optics unit 14 are thus protected, for example, against dust inside the vehicle. An optical film or a polarizer 24 may furthermore be located on the cover plate 23. The display element 11 is typically polarized, and the mirror unit 2 acts like an analyzer. The purpose of the polarizer 24 is therefore to influence the polarization in order to achieve uniform visibility of the useful light. A cover assembly 25 arranged on the cover plate 23 serves to reliably absorb the light reflected via the boundary of the cover plate 23 so that the observer is not dazzled. In addition to the sunlight SL, the light from another stray light source 5 may also reach the display element 11. In combination with a polarization filter, the polarizer 24 may additionally also be used to reduce incident sunlight SL.

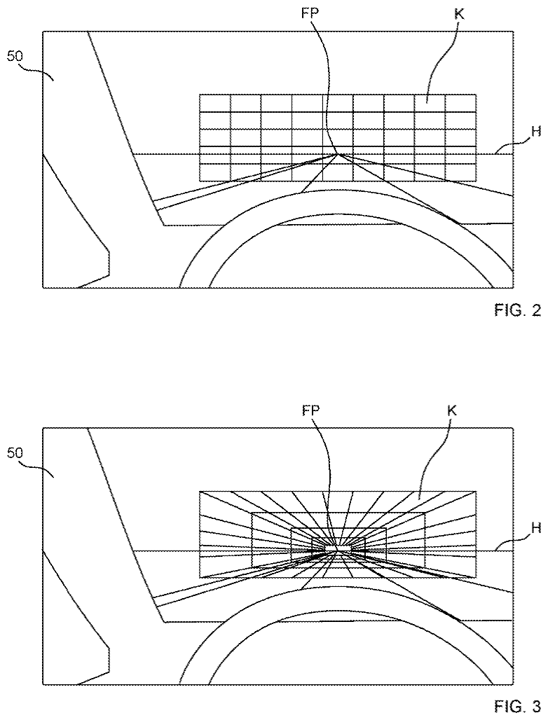

FIG. 2 shows a subdivision of an image to be displayed into rectangular partial areas K. The illustration shows the resulting virtual image VB and the partial areas K from the viewpoint of the driver of a transport 50. The partial areas K are rectangles of uniform size. It is readily discernible that the partial areas K in the region of the vanishing point FP or the horizon H cover a larger perceived region of the surroundings than partial areas K at the edge of the image. By way of example, the partial area K at the vanishing point FP extends over the entire width of the road, while the partial areas K at the lower edge each cover only a fraction of the road.

FIG. 3 shows a subdivision of an image to be displayed into trapezoidal partial areas K with a varying size. The illustration once again shows the resulting virtual image VB and the partial areas K from the viewpoint of the driver of a transport 50. The partial areas K have a decreasing size from the edge of the image to the vanishing point FP. Since the perceived size of an object varies with the distance of the object, the partial areas K are small in those regions of the image which overlay objects far away. At the sides of the image, the perceived objects are nearer; therefore, the partial areas K may also be larger. In addition, in the example shown, the region of the vanishing point FP is totally omitted from the display of image elements, which is indicated by the central rectangle.

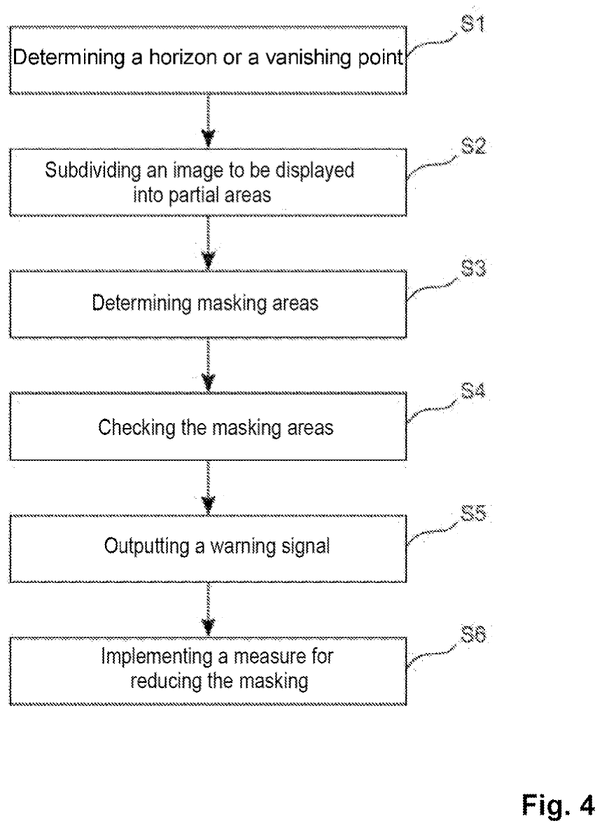

FIG. 4 schematically shows a method for reducing masking by a virtual image of a head-up display of a transport. In a first step, a horizon and/or a vanishing point are determined S1. For the purpose of determining S1 the horizon, an inclination of the transport may be determined beforehand. For the purpose of determining S1 the vanishing point, on the other hand, a viewing direction of an observer may be determined. Afterward, an image to be displayed is subdivided S2 into a plurality of partial areas. In this case, the partial areas are trapezoidal and their size varies over the area of the image to be displayed. The partial areas have a decreasing size from an edge region of the image to be displayed to the horizon and/or to a vanishing point. Masking areas are determined S3 for the individual partial areas. In this case, e.g. a transparency of the partial areas may be considered as a measure of the masking area. Finally, checking S4 is carried out to ascertain whether the determined masking area exceeds a permissible size for at least one of the partial areas. If this is the case, a warning signal is output S5. Before outputting a warning signal, optionally checking may be carried out to ascertain whether the determined masking area exceeds a permissible size for two or more adjacent partial areas. Finally, at least one measure for reducing the masking is implemented S6 in response to the warning signal. In this case a display of image elements in the region of the horizon or in the region of the vanishing point is prevented.

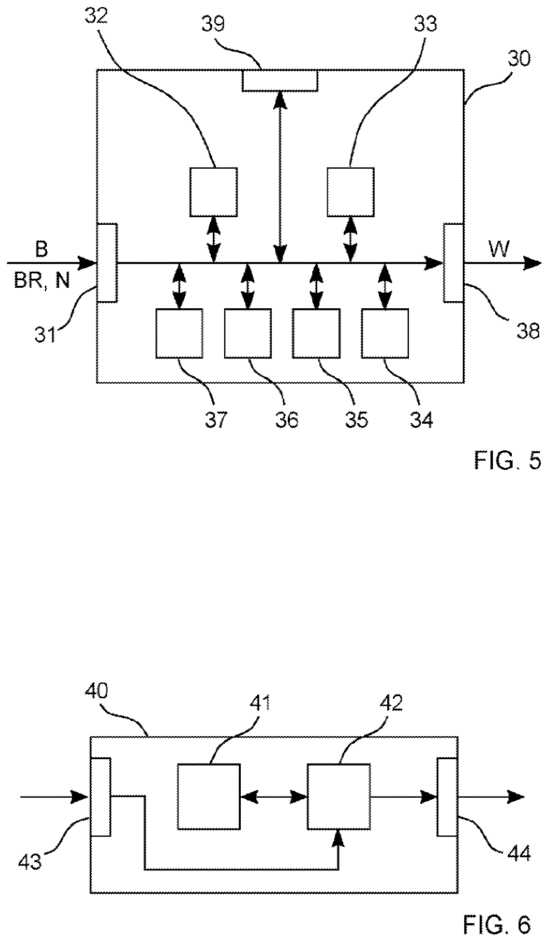

FIG. 5 shows a simplified schematic illustration of a first embodiment of a device 30 for reducing masking by a virtual image of a head-up display of a transport. The device 30 has an input 31, via which an image B to be displayed is received. Information N, BR may additionally be received via the input 31, from which information an evaluation module 32 may determine a horizon and/or a vanishing point. For the purpose of determining the horizon, e.g. an inclination N of the transport may be evaluated. For the purpose of determining the vanishing point, on the other hand, a viewing direction BR of an observer may be evaluated. A subdividing module 33 is configured to subdivide the image B to be displayed into a plurality of partial areas. In this case, the partial areas are trapezoidal and their size varies over the area of the image B to be displayed. The partial areas have a decreasing size from an edge region of the image B to be displayed to the horizon and/or to a vanishing point. A processing module 34 is configured to determine masking areas for the individual partial areas. In this case, the processing module 34 may consider e.g. a transparency of the partial areas as a measure of the masking area. The processing module 34 is additionally configured to check whether the determined masking area exceeds a permissible size for at least one of the partial areas. A warning module 35 is configured to output a warning signal W if this is the case. Before outputting a warning signal W, the processing module 34 may optionally check whether the determined masking area exceeds a permissible size for two or more adjacent partial areas. The warning signal W may be output via an output 38 of the device 30, e.g. in order to initiate at least one measure for reducing the masking. In this case a display of image elements in the region of the horizon or in the region of the vanishing point is prevented.

The evaluation module 32, the subdividing module 33, the processing module 34 and the warning module 35 may be controlled by a control module 36. If appropriate, settings of the evaluation module 32, of the subdividing module 33, of the processing module 34, of the warning module 35, or of the control module 36 can be changed via a user interface 39. The data that accrue in the device 30 may be stored in a memory 37 of the device 30 if necessary, for example for later evaluation or for use by the components of the device 30. The evaluation module 32, the subdividing module 33, the processing module 34, the warning module 35 and the control module 36 may be realized as dedicated hardware, for example as integrated circuits. Of course, however, they may also be implemented partially or completely in combination or as software that runs on a suitable processor, for example on a GPU or a CPU. The input 31 and the output 38 may be implemented as separate interfaces or as a combined interface.

FIG. 6 shows a simplified schematic illustration of a second embodiment of a device 40 for reducing masking by a virtual image of a head-up display of a transport. The device 40 has a processor 42 and a memory 41. For example, the device 40 is a controller or an embedded system. Stored in the memory 41 are instructions which, when executed by the processor 42, cause the device 40 to carry out the steps according to one of the methods described. The instructions stored in the memory 41 thus embody a program which is executable by the processor 42 and which realizes the method according to the disclosure. The device 40 has an input 43 for receiving information. Data generated by the processor 42 are provided via an output 44. Furthermore, the data can be stored in the memory 41. The input 43 and the output 44 can be combined to form a bidirectional interface.

The processor 42 may comprise one or more processor units, for example microprocessors, digital signal processors, or combinations thereof.

The memories 37, 41 of the described devices may have both volatile and nonvolatile memory areas and may comprise a wide variety of storage devices and storage media, for example hard disks, optical storage media, or semiconductor memories.

1. A method for reducing masking by a virtual image of a head-up display of a transport, the method comprising:
subdividing an image to be displayed into a plurality of partial areas, wherein the partial areas are trapezoidal and their size varies over the area of the image to be displayed;
determining masking areas for individual partial areas; and
outputting a warning signal if the determined masking area exceeds a permissible size for at least one of the partial areas.

2. The method as claimed in claim 1, wherein when determining the masking areas, a transparency of the partial areas is considered as a measure of the masking area.

3. The method as claimed in claim 1, wherein before outputting a warning signal, checking is carried out to ascertain whether the determined masking area exceeds a permissible size for two or more adjacent partial areas.

4. method as claimed in claim 1, wherein the partial areas have a decreasing size from an edge region of the image to be displayed to a horizon and/or to a vanishing point.

5. The method as claimed in claim 4, wherein determining the horizon is carried out by determining an inclination of the transport and/or determining the vanishing point is carried out by determining a viewing direction of an observer.

6. The method as claimed in claim 4, wherein at least one measure for reducing the masking is implemented in response to the warning signal.

7. The method as claimed in claim 6, wherein a display of image elements in the region of the horizon or in the region of the vanishing point is prevented.

8. A computer program comprising instructions which, when executed by a computer, cause the computer to carry out the steps for reducing masking by a virtual image of a head-up display of a transport, comprising:
subdividing an image to be displayed into a plurality of partial areas, wherein the partial areas are trapezoidal and their size varies over the area of the image to be displayed;
determining masking areas for the individual partial areas; and
outputting a warning signal if the determined masking area exceeds a permissible size for at least one of the partial areas.

9. A device for reducing masking by a virtual image of a head-up display of a transport, comprising:
a subdividing module for subdividing an image to be displayed into a plurality of partial areas, wherein the partial areas are trapezoidal and their size varies over the area of the image to be displayed;
a processing module for determining masking areas for the individual partial areas; and
a warning module for outputting a warning signal if the determined masking area exceeds a permissible size for at least one of the partial areas.

10. The device as claimed in claim 9, wherein the device is configured in a head-up display.
